(19) United States
(12) Patent Application Publication
(10) Pub. No.: US 2005/0225889 A1
(43) Pub. Date: Oct. 13, 2005

(54) Magnetic media read signal filter

(76) Inventors: Steven L. Brittenham, Boise, ID (US); Gary Bartles, Wilder, ID (US)

Correspondence Address: HEWLETT-PACKARD COMPANY;INTELLECTUAL PROPERTY ADMINISTRATION, P.O. BOX 272400, FORT COLLINS, CO, 80527-2400, US

(21) Appl. No.: 10/969,111

(22) Filed: Oct. 20, 2004

Related U.S. Application Data
(60) Provisional application No. 60/561,753, filed on Apr. 13, 2004.

(51) Int. Cl. G11B 5/09

(52) U.S. Cl. 360/46

(57) ABSTRACT

In one embodiment, a magnetic media read signal filter that includes an infinite impulse response filter configured to remove from a read signal pulse an artifact of write equalization. In another embodiment, a magnetic media read signal filter that includes an infinite impulse response filter configured to suppress an undershoot in a trailing edge of a read signal pulse.

### CROSS REFERENCE TO RELATED APPLICATIONS

This application claims the priority of provisional application Ser. No. 60/561,753 filed Apr. 13, 2004.

### BACKGROUND

Binary information is stored on tape by magnetizing small areas of the magnetic surface with one of two polarities. When writing data, a current is passed through an inductive head. A change in current from positive to negative sets the polarity of the media area adjacent to the head to one polarity; a current transition from negative to positive sets the opposite polarity. The transition between polarities is called a flux transition. A flux transition occurring at a data bit location may represent a “one” bit, and no flux transition may represent a “zero” bit. When reading data, a read head passes through magnetic fields from the small magnetized areas. As the head passes through the fields, a transition from one polarity to the opposite polarity results in a changing field that in turn induces a current change in the read head. In an inductive read head, the magnetic flux change induces a current in an inductive coil. In a magneto-resistive head, the magnetic flux change varies the resistance of the head, varying the current through the head. Thus, the flux transitions are converted into voltage pulses, so that the information in the read signal is encoded in the temporal spacing of pulse peaks. A pulse is a single vibration of voltage or current in a signal. For data integrity, the accuracy of the timing of the peaks in the read signal is critical. For an ideal media, writing an isolated transition from one polarity to the opposite polarity results in perfectly symmetrical magnetic areas on the media and a perfectly symmetrical voltage pulse during reading. However, for typical magnetic media, the transition results in an asymmetrical voltage pulse, also referred to as a peak shift. As bit densities increase, the transitions occur very close together and are no longer isolated. The combined effects of peak shift and adjacent pulses make the time between pulses on read-back longer than the time between the transitions during writing. Shifting the time of the read pulse from its ideal time may introduce errors in the read data.

Given a particular digital pattern in the write waveform, it is possible to predict some of the resulting distortion in the read waveform. Write equalization is the technique of deliberately distorting the write signal to make the resulting read signal closer to an ideal signal. For example, if two adjacent write transitions are very close together, then the first transition may be written late and the second transition written early. As a result, the time between transitions during writing is shorter than the ideal time, and the time between pulses during read back is equal or closer to the ideal time. In another example, the shape of each read pulse can be controlled by inserting extra pulses in the write waveform. Typically, the frequency response of the magnetic head is such that these extra pulses do not result in complete polarity reversals in the surface of the data storage medium; instead, the fields on the magnetic medium are slightly modified to compensate for distortion in the resulting read signals.

Moreover, with increasing bit density and increasing transfer rate, the fields produced by adjacent flux transitions superpose destructively so that the magnitude of the signal induced at the read head decreases. The interference from adjacent transitions is commonly called intersymbol noise. In a Partial Response, Maximum Likelihood (PRML) read channel, partial response signaling is used to reduce the interference from adjacent transitions, and maximum likelihood detection is used to minimize the noise effects. The PRML technique requires that the read pulse approximate an ideal symmetric waveform specified by the system designer, called the PRML target. Variance of the read pulse from the PRML target may introduce errors in the read data. Unfortunately, the introduction of write equalization to shift the read pulse to its ideal location in time distorts the symmetry of the read pulse, potentially producing errors during symbol detection using the PRML technique. Write equalization can also cause an undershoot, an artifact in the read signal defined as a perturbation having a maximum amplitude less than the quiescent read voltage, also called a negative perturbation. Write equalization typically causes an undershoot in the trailing edge of the read pulse.

Finally, other sources of noise introduce additional undesirable artifacts in the read signal. These artifacts may include noise from amplifiers or reflections of the read signal from inductive elements in the read circuit, such as an inductive read head.

The process of filtering the read signal to remove the distortion and restore each read pulse to approximately its ideal shape is called read equalization. Read equalization has two primary objectives: remove the artifacts caused by write equalization and conform each read pulse to the PRML target.

Filters are electronic circuits that change the characteristics of a signal, such as eliminating undesirable artifacts, changing pulse shape, or removing selected frequency components. Filters may be either analog filters or digital filters. An analog filter is implemented as an analog circuit and operates on an analog signal, a signal that is variably continuous in time. Analog circuits typically contain elements such as resistors, capacitors, amplifiers, and the like. A digital filter is implemented as a digital circuit and operates on a digital signal, the numerical representation of a continuous time signal. Digital circuits typically contain such elements as logic gates, registers, and the like. Digital signals may be generated from analog signals using an analog-to-digital converter (ADC). An ADC converts an analog signal to a digital signal by sampling the amplitude of the analog signal at a fixed time interval, called the sampling period. The resulting stream of numerical sampled data is a digital signal.

### DRAWINGS

FIG. 1 is a block diagram of a magnetic tape drive.

FIG. 2 is a block diagram of one implementation of a read channel.

FIG. 3 is a graph showing a read signal with a trailing edge undershoot characteristic of write equalization.

FIG. 4 is a graph showing a read signal conforming to a PRML target shape.

FIG. 5 is a block diagram illustrating a finite impulse response (FIR) filter.

FIG. 6 is a block diagram of one implementation of a read channel.

FIG. 7 is a block diagram of one implementation of a read channel.

FIG. 8 is a block diagram illustrating an infinite impulse response (IIR) filter.

### DESCRIPTION

Embodiments of the present invention were developed in an effort to eliminate, when reading data from magnetic media, the undesirable undershoot characteristic of write equalization. Embodiments will be described with reference to the tape drive shown in FIG. 1. Embodiments of the invention, however, are not limited to use with tape drives. Embodiments may be implemented in other magnetic storage products, such as hard disks. While embodiments of the invention are not limited to use with tape drives, it is expected that various embodiments will be particularly useful in tape drives.

FIG. 1 shows the components of a tape drive 10 associated with read and write operations. Magnetic tape 12 feeds from a supply reel 14 to a take-up reel 16, passing by a read and write head 18. An actuator 20 positions head 18 over the track to read from or write on tape 12. During a read operation, signals pass from head 18 to a read channel 22 located on a controller 24. During a write operation, signals pass from a write channel 26 to head 18. Controller 24, which includes a microprocessor 27, controls the operation of the tape drive, including reels 14 and 16, actuator 20, read channel 22 and write channel 26. Controller 24 receives read instructions, write instructions and data from a computer or other host. Although only one head 18 and associated read channel 22 and write channel 26 are shown, a typical tape drive will usually have an array of many such heads formed in a composite head structure; and the controller will include a read channel and a write channel for each head in the array. In some tape drives, separate read heads and write heads are used instead of combined read and write heads.

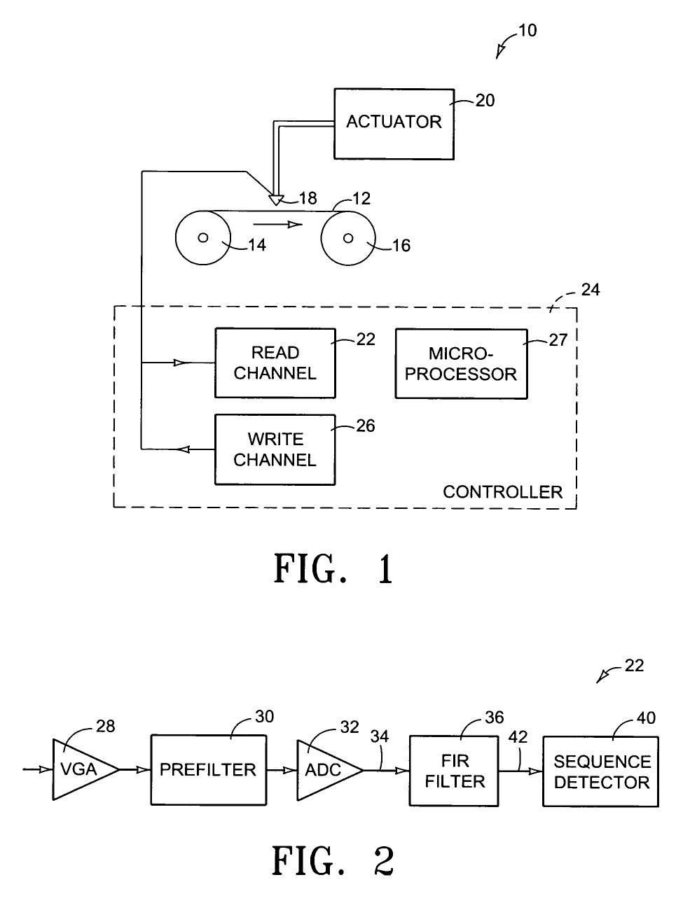

FIG. 2 shows one implementation of a read channel 22 in controller 24 of tape drive 10 of FIG. 1. Referring to FIG. 2, a head 18 (FIG. 1) sends the read signal to variable gain amplifier (VGA) 28, which amplifies the signal to a constant average level. An analog prefilter 30 performs some initial equalization of the amplified read signal before the signal is digitized by an analog-to-digital converter (ADC) 32. Prefilter 30 is usually configured to remove some of the undesirable artifacts in the read signal. Prefilter 30 is often simply a low-pass analog filter. Alternatively, prefilter 30 may be implemented as a digital filter located immediately following ADC 32. In some tape drives, prefilter 30 is eliminated altogether. ADC 32 outputs a digital signal 34 to a finite impulse response (FIR) filter 36.

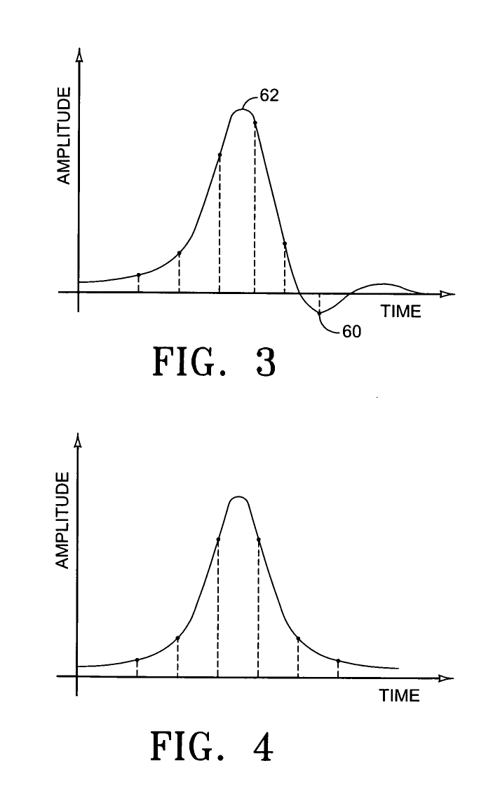

FIG. 3 illustrates a single pulse in the read signal 34 of FIG. 2. The shape of the pulse is characteristic of a tape drive employing a magneto-resistive head 18 with write equalization. Returning to FIG. 2, FIR filter 36 equalizes signal 34 to approximate the required pulse shape for detection by a sequence detector 40. Filter 36 outputs a filtered signal 42 to sequence detector 40. A sequence detector 40 includes a circuit that recognizes one or more sequences of pulses and generates a specific output for each recognized sequence. FIG. 4 illustrates a PRML target pulse shape for signal 42.

An FIR filter, such as filter 36 in FIG. 2, is a filter whose impulse response has a finite number of non-zero terms. The impulse response of a filter is defined as the output of the filter when a unit impulse function is applied to the input and all initial conditions are zero. An FIR filter operates by passing the input pulse through a series of delays, scaling the output of each delay, then adding the resulting pulses to generate the output.

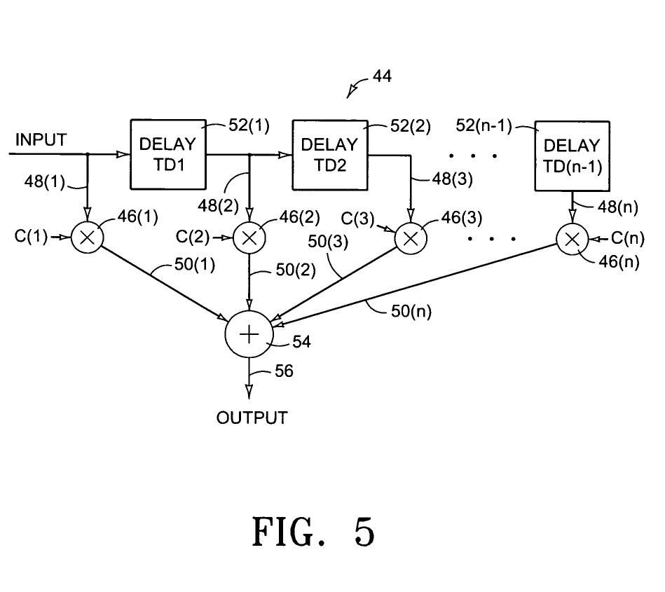

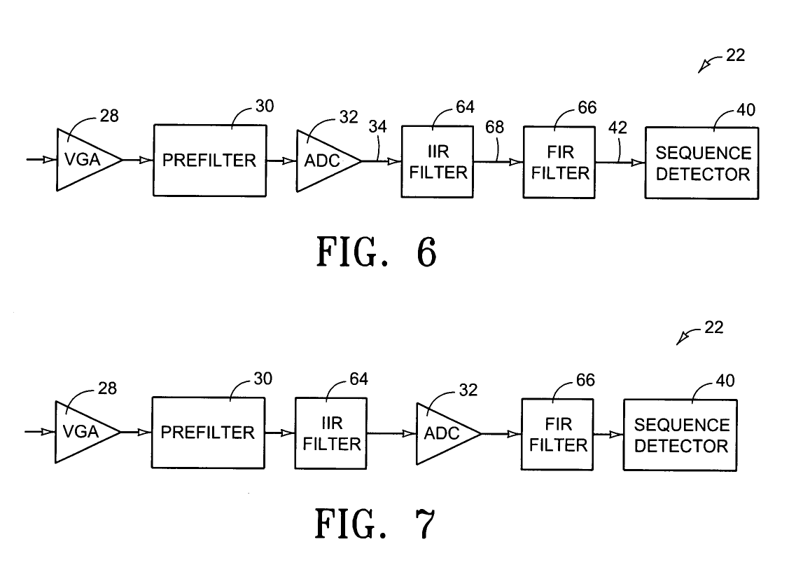

FIG. 5 is a block diagram illustrating an “n” tap FIR filter 44 such as might be used for filter 36 in FIG. 2. FIR filters can be implemented as either analog or digital filters, although digital filters are commonly used in tape drives. Those skilled in the art will recognize that there are many circuit topologies available to implement an FIR filter, not limited to the example shown in FIG. 5. Referring to FIG. 5, FIR filter 44 includes a plurality of “n” multipliers 46(1)-46(n) which scale their respective input pulses 48(1)-48(n) by coefficients C(1)-C(n) to output pulses 50(1)-50(n). A plurality of “n−1” time delays 52(1)-52(n−1) delay a copy of input pulses 48(1)-48(n−1) by times TD(1)-TD(n−1) to output pulses 48(2)-48(n). Adder 54 adds pulses 50(1)-50(n) output from multipliers 46(1)-46(n) to output a filtered pulse 56. Each pulse 50(1)-50(n) output by a multiplier 46(1)-46(n) is called a tap. The scaling coefficient C(1)-C(n) for each multiplier 46(1)-46(n) and the value of the associated time delay TD(1)-TD(n−1) defines the tap weight for each tap. In digital filters, the time delay values and scaling coefficients are often programmable.

A tape drive using an magneto-resistive head requires two read equalization functions to be performed on the read signal: suppress the undershoot caused by write equalization, and reshape the read pulse to conform to the PRML target shape. As shown in FIG. 3, an undershoot 60 caused by write equalization appears on the trailing edge of read pulse 62. Write equalization artifacts, however, may appear in other ways. For example, if an artifact is present when each pulse is written and subsequently read back, then it doesn't matter if the artifact visually looks like it is “attached” to the pulse (e.g., an undershoot without any inflection at the DC baseline) or not (e.g., what looks like a separate undershoot). It has been observed that, where the leading-to-trailing edge asymmetry is not visually obvious and there is no trailing edge undershoot per se, when conventional filtering is applied to the pulse, the subtle asymmetry is exaggerated into an obvious undershoot. FIR filters designed to perform both equalization functions necessarily combine copies of the undesirable write equalization undershoot as well as the desirable read pulse. The asymmetric nature of the undesirable undershoot combined with its proximity to the read pulse requires a large number of taps to suppress the undershoot without distorting the read pulse. A large number of filter taps results a high component count, high expense, and undesirable propagation delay.

Rather than using a “beefed-up” FIR to perform both equalization functions, embodiments of the present invention utilize an infinite impulse response (IIR) filter to suppress the trailing edge undershoot caused by write equalization. For example, and referring to the implementation of a read channel 22 shown in FIG. 6, an IIR filter 64 configured to suppress the asymmetric write equalization undershoot is used in series with an FIR filter 66 configured to reshape the read pulse to conform to a PRML target shape. The read channel of FIG. 6 includes variable gain amplifier (VGA) 28, analog prefilter 30, and analog-to-digital converter (ADC) 32. ADC 32 outputs a digital signal 34 output to IIR filter 64. IIR filter 64 suppresses trailing edge undershoot 60 (FIG. 3) and outputs a filtered signal 68 to FIR filter 66 which, in turn, outputs the fully filtered signal 42 to sequence detector 40.

FIR filter 66 can be made more simple with many fewer taps and less propagation delay than FIR filter 36 in FIG. 2. IIR filter 64 may be positioned in series before or after FIR filter 66 in read channel 22. While it is expected that in most tape drive applications, both IIR filter 64 and FIR filter 66 will be implemented as digital circuits, in part to allow easy programmability of the tap weights, either or both IIR filter 64 and FIR filter 66 may be implemented as an analog circuit. Analog filters must be placed upstream from ADC 32. For example, in the read channel shown in FIG. 7 IIR filter 64 is an analog filter positioned upstream from ADC 32. Implementing both filters 64 and 66 as analog circuits allows the elimination of ADC 32.

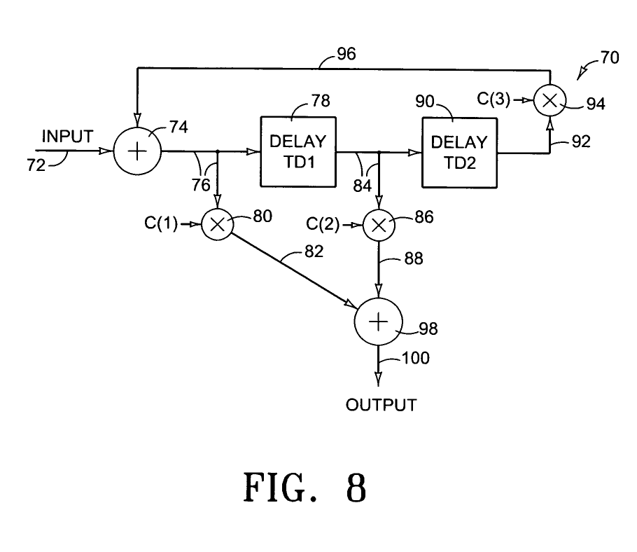

FIG. 8 illustrates an IIR filter 70 such as might be used as filter 64 in FIG. 6. Those skilled in the art will recognize that there are many circuit topologies available to implement an IIR filter 64 in FIG. 6, not limited to the example shown in FIG. 8. Referring to FIG. 8, input pulse 72 enters IIR filter 70 at an adder 74, which outputs pulse 76 to delay 78 and multiplier 80. Multiplier 80 scales pulse 76 by coefficient C(1) to output pulse 82. Delay 78 delays a copy of pulse 76 by time TD1 to output pulse 84. A second multiplier 86 scales pulse 84 by coefficient C(2) to output pulse 88. A second delay 90 delays a copy of pulse 84 by time TD2 to output pulse 92. A third multiplier 94 scales pulse 92 by coefficient C(3) to output a feedback pulse 96. Adder 74 adds feedback pulse 96 to input pulse 72 to output pulse 76. A second adder 98 adds pulses 82 and 88 to output filtered pulse 100. Utilizing a feedback pulse, an IIR filter adds an infinite number of scaled and delayed copies of the input pulse to generate the output/filtered pulse. The feedback causes the IIR filter to behave as if it has a large number of taps without adding the cost of the circuit elements required to implement the taps in an FIR filter.

Tap weights for the IIR filter are chosen to make the input pulse (FIG. 3) symmetric after equalization. IIR tap weights can be generated either empirically or systematically through IIR filter designers such as the commercially available program MATLAB from The MathWorks, Inc. of Natick, Mass. Once the output of the IIR filter is known, or the equivalent information is derived from the convolution of the input pulse (FIG. 3) and the IIR tap weights, the FIR filter tap weights may be computed from the target pulse (FIG. 4) using a mathematical tool such as Levinson-Durbin deconvolution. Levinson-Durbin equations may be solved using MATLAB. Alternatively, the FIR filter tap weights may be found empirically in an actual tape drive environment.

The exemplary embodiments shown in the figures and described above illustrate but do not limit the invention. Other forms, details, and embodiments may be made and implemented. Hence, the foregoing description should not be construed to limit the scope of the invention, which is defined in the following claims.

1. A magnetic media read signal filter, comprising an infinite impulse response filter configured to suppress in a read signal pulse an artifact of write equalization.

2. The filter of claim 1, wherein the artifact comprises an undershoot in a trailing edge of the read signal pulse.

3. The filter of claim 1, wherein the artifact comprises an undershoot trailing the read signal pulse.

4. A magnetic media read signal filter, comprising an infinite impulse response filter configured to suppress an undershoot in a trailing edge of a read signal pulse.

5. The filter of claim 4, wherein the trailing edge undershoot is characteristic of write equalization.

6. The filter of claim 4, wherein the infinite impulse response filter is configured to receive an input comprising asymmetric pulses and output symmetric pulses.

7. The filter of claim 6, wherein the infinite impulse response filter includes:
a first adder;
a second adder;
a plurality of multipliers;
a plurality of delays;
the first adder adding an input pulse and a feedback pulse from one of the multipliers and outputting a pulse to a multiplier and to a delay;
each delay delaying a pulse from the first adder or from another delay and outputting a pulse to a multiplier or to another delay, or to both;
each multiplier scaling a pulse from the first adder or from a delay and outputting a pulse to an adder; and
the second adder adding pulses output by a plurality of multipliers and outputting the output pulse.

8. An electronic circuit for filtering a signal produced by reading data from magnetic media, comprising:
a finite impulse response filter; and
an infinite impulse response filter in series with the finite impulse response filter, the infinite impulse response filter configured to suppress in a read signal pulse an artifact of write equalization.

9. The circuit of claim 8, wherein the artifact comprises an undershoot in a trailing edge of the read signal pulse.

10. The circuit of claim 8, wherein the infinite impulse response filter is configured to suppress an undershoot in a trailing edge of a read signal pulse and the finite impulse response filter is configured to conform the read signal pulse to a Partial Response, Maximum Likelihood target.

11. An electronic circuit for filtering a signal produced by reading data from magnetic media, comprising:
a variable gain amplifier;
an infinite impulse response filter downstream from and in series with the variable gain amplifier;
a finite impulse response filter downstream from the variable gain amplifier and in series with the variable gain amplifier and the infinite impulse response filter; and
a sequence detector downstream from and in series with the infinite impulse response filter and the finite impulse response filter.

12. The circuit of claim 11, wherein the finite impulse response filter is downstream from the infinite impulse response filter.

13. The circuit of claim 11, wherein the infinite impulse response filter is downstream from the finite impulse response filter.

14. A read channel for a magnetic storage device having a magneto-resistive read head, the read channel comprising:
a variable gain amplifier;
an infinite impulse response filter;
a finite impulse response filter;
the infinite impulse response filter and the finite impulse response filter in series with one another downstream from the variable gain amplifier; and
a sequence detector in series with and downstream from the filters.

15. The read channel of claim 14, further comprising an analog to digital converter in series with and upstream from the infinite impulse response filter and the finite impulse response filter.

16. The read channel of claim 14, further comprising an analog to digital converter between the infinite impulse response filter and the finite impulse response filter.

17. The read channel of claim 14, wherein the infinite impulse response filter is configured to suppress an undershoot in a trailing edge of a read signal pulse.

18. The read channel of claim 17, wherein the trailing edge undershoot is characteristic of write equalization.

19. The read channel of claim 14, wherein the infinite impulse response filter is configured to suppress an undershoot in a trailing edge of a read signal pulse and the finite impulse response filter is configured to conform the read signal pulse to a Partial Response, Maximum Likelihood target.

20. A tape drive, comprising:
a magneto-resistive read head;
a tape take-up reel;
a head actuator operative to move the head across a tape path extending past the head to the take-up reel;
a read channel comprising a variable gain amplifier, an infinite impulse response filter, a finite impulse response filter, the infinite impulse response filter and the finite response filter in series with one another downstream from the variable gain amplifier, and a sequence detector in series with and downstream from the filters; and
an electronic controller configured to receive read and write instructions and data from a computer or other host device and to control operation of the take-up reel, the actuator, the head, and the read channel.

21. The tape drive of claim 20, wherein the read channel is part of the controller.
